(19) United States
(12) Patent Application Publication
(10) Pub. No.: US 2015/0233345 A1
(43) Pub. Date: Aug. 20, 2015

(54) WIND TURBINE BLADE

(71) Applicant: SIEMENS AKTIENGESELLSCHAFT, München (DE)

(72) Inventors: Anders Smaerup Olsen, Frederiksberg (DK); Michael J. Asheim, Golden, CO (US)

(73) Assignee: Siemens Aktiengesellschaft, Munich (DE)

(21) Appl. No.: 14/429,050

(22) PCT Filed: Mar. 7, 2013
(86) PCT No.: PCT/EP2013/054602

§ 371 Date: Mar. 18, 2015

Related U.S. Application Data
(60) Provisional application No. 61/704,600, filed on Sep. 24, 2012.

(51) Int. Cl. F03D 1/06; F03D 9/00

(52) U.S. Cl. CPC F03D 1/0633; F03D 9/002

(57) ABSTRACT

A wind turbine blade having a noise reducing device attached at its trailing edge including serrations, whereby the serrations and the trailing edge include an angle between 75° and 90° is provided. The wind turbine blade may be provided wherein the angle is between 80° and 90°. In an embodiment, the wind turbine blade may be provided wherein a serration has a rounded shape at its tip and/or its notch. A wind turbine including a tower, an electrical generator with a rotor shaft and a hub to which wind turbine blades are connected, wherein the wind turbine includes wind turbine blades.

### CROSS REFERENCE TO RELATED APPLICATIONS

This application is the US National Stage of International Application No. PCT/EP2013/054602 filed Mar. 7, 2013, and claims the benefit thereof. The International Application claims the benefit of U.S. Provisional Application No. 61/704,600 filed Sep. 24, 2012. All of the applications are incorporated by reference herein in their entirety.

### FIELD OF INVENTION

The present invention relates to a wind turbine blade having a noise reducing device attached at its trailing edge comprising serrations.

### BACKGROUND OF INVENTION

Wind turbine blades generate aerodynamic noise when the wind turbine operates and the rotor is in rotational movement. In general aerodynamic noise source mechanisms for lifting air-foils can be classified as follows: a) turbulent boundary-layer flow shed off of the trailing edge, b) separated boundary-layer and stalled airfoil flow, c) vortex shedding due to laminar boundary-layer instabilities, and d) vortex shedding from blunt trailing edges.

It was found out that the main source of aerodynamic noise originates at the trailing edge of the outer span of wind turbine blades. A surprising finding was that noise from the blade tip is of minor importance. It was also found that noise produced by the blades is proportional to the wind speed (i.e. rotational speed) at the blades.

Noise sets a limitation on how close a wind turbine can be built to residential areas and at what rotational frequency a rotor of a wind turbine can rotate.

It is well known to optimise wind turbine blades in the design phase to reduce aerodynamic noise. The attachment of noise reducing devices to the trailing edge of wind turbine blades as a retrofit or after production is well known in the wind turbine industry. One example for a noise reducing device is a serrated plastic plate as a part of a retrofit package attached to the trailing edge of wind turbine blades.

The attachment or production of wind turbine blades with winglets is another means to reduce noise from the wind turbine blade.

EP 1314885 A1 discloses a flexible serrated trailing edge for wind turbine rotor blades. In order to improve the efficiency of an existing wind turbine rotor it is proposed to attach a serrated panel to at least a part of the trailing edge of the wind turbine blades. By using serrated trailing edges the lift and drag characteristics of a lifting surface can be improved.

EP 0652367 A1 proposes a wind turbine having a trailing edge with a saw-tooth form. In order to obtain this form a saw-tooth-shaped strip can be used which is fixed to the trailing edge of the rotor blade.

US 2008/0166241 A1 discloses a wind turbine blade brush with bristles or a brush disposed on an outer surface of the wind turbine blade. The function of the bristles is to achieve a noise reduction effect. The bristles can be arranged in at least one row along a longitudinal direction of the blade or in the vicinity of a trailing edge.

DE 10340978 B1 similarly discloses a wind turbine blade with a brush attached to the trailing edge wherein single fibers of the brush branch out. The branches of the brush imitate feathers of an owl.

### SUMMARY OF INVENTION

It is an object of the present invention to provide a wind turbine blade with an efficient noise reducing device.

According to an embodiment of the present invention this object is achieved in the above defined wind turbine blade in that the serrations and the trailing edge include an angle between 75° and 90°.

The present invention is based on the idea that aerodynamic noise can be reduced significantly by using a serrated trailing edge with serrations having a modified shape and dimension compared to conventional serrations with a triangular shape. The angle which is included between the serrations and the trailing edge is of particular importance. In conventional serrations, e.g. serrated plastic plates, which are sold by the applicant as “DinoTails” said angle between serrations and trailing edge is between 45° and 55°. However, to use modified serrations which include an angle between 75° and 90° with the trailing edge is beneficial for the noise reduction effect. Simulations and tests have shown that it is advantageous to have serrations edges running almost parallel to the airflow to reduce aerodynamic noise.

According to a preferred embodiment of the inventive wind turbine blade said angle can be between 80° and 90° . It is particularly preferred that the angle is between 75° and 90° . In general it is preferred to use serrations with an angle which is close to 90°.

In order to further reduce the emission of aerodynamic noise it may be envisaged that a serration has a rounded shape at its tip and/or its notch. As sharp edges are avoided a smooth airflow is achieved which prevents the generation of unwanted aerodynamic noise.

Similarly it may be envisaged that a serration has a decreasing thickness towards it opposite lateral sides. Accordingly the aerodynamic drag is reduced and an optimal noise reduction is achieved.

According to a further development of the inventive wind turbine blade a serration may have a length of 15% to 25% of the chord of the wind turbine blade, preferably the length is approximately 20% of the chord.

According to the invention the serrations can be arranged in a section ranging approximately from 75% to 95% of the span of the wind turbine blade. It was found out that this section is particularly relevant in order to reduce aerodynamic noise by using a serrated trailing edge.

In order to simplify the production of the serrated trailing edge it may be envisaged that the serrations are printed by a 3D printer. This production technology provides the ability to give the serrations a specific stiffness. As an alternative the serrations can be made of casted plastic or cut out and machined from a plate.

An embodiment of the invention further relates to a wind turbine, including a tower, an electrical generator with a rotor shaft and a hub to which wind turbine blades are connected.

The inventive wind turbine may include the inventive wind turbine blades.

### BRIEF DESCRIPTION OF THE DRAWINGS

Embodiments of the invention and its underlying principle will be better understood when consideration is given to the following detailed description of preferred embodiments.

In the accompanying drawings:

FIG. 1 is a top view of an inventive wind turbine blade;

FIG. 2 is a top view of a trailing edge comprising serrations; and

FIG. 3 is a perspective view of a detail of the trailing edge comprising serrations.

### DETAILED DESCRIPTION OF INVENTION

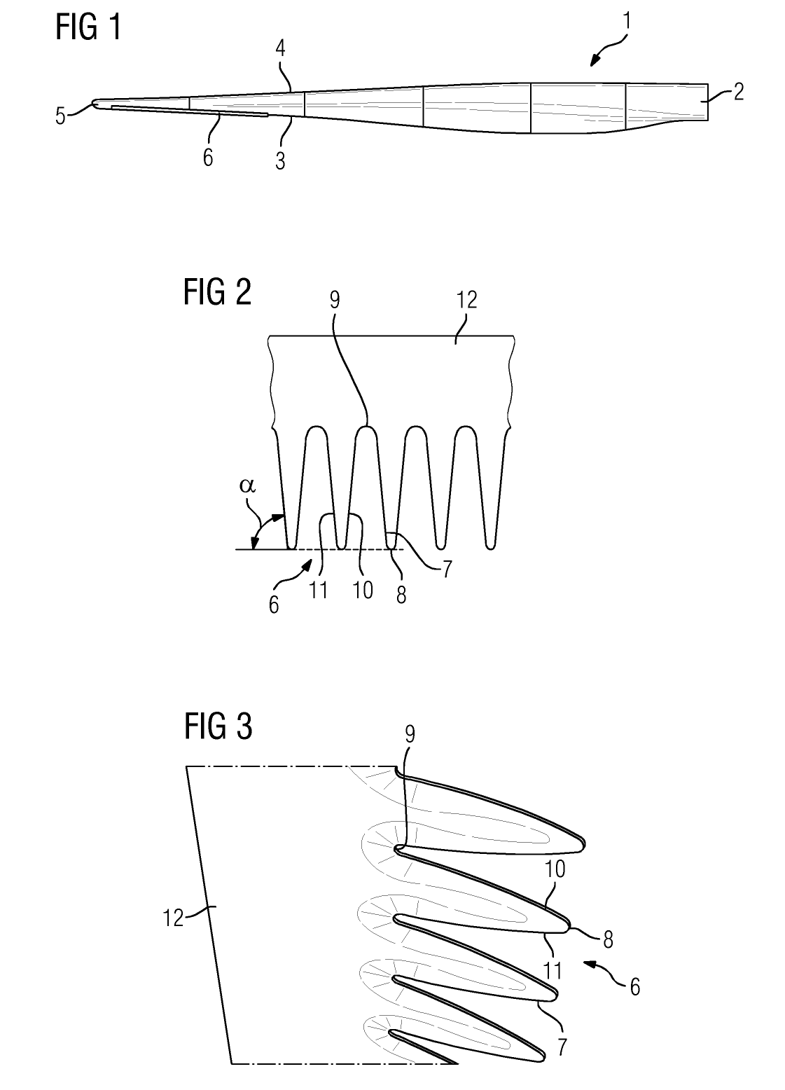

FIG. 1 is a top view of a wind turbine blade 1 with a blade root 2 where it is connected to a hub of a rotor, which is part of an electrical generator. Further the wind turbine blade 1 includes a trailing edge 3, a leading edge 4 and a blade tip 5.

At the trailing edge 3 a noise reducing device in the form of serrations 6 is attached. The serrations 6 are arranged in a section ranging approximately from 75% to 95% of the span of the wind turbine blade 1.

FIG. 2 shows a detail of the serrations 6 and FIG. 3 is a perspective view of the trailing edge 3 comprising serrations 6. In FIG. 2 one can see that the serrations 6 have a smooth shape similar to a bird feather. Typically the length of a serration is in the range of 65 mm to 300 mm corresponding to approximately 20% chord. Edges 7 of the serrations run almost parallel to the airflow in order to reduce aerodynamic noise. Consequently the serrations 6 and the trailing edge 3 include an angle between 85% and 90%.

The noise reducing device comprising the serrations 6 is optimised by shaping of the serrations 6 causing an angle α between the serrations 6 and the trailing edge 3 to be more optimal for noise reduction.

A serration 6 has a rounded shape at its tip 8 as well at its notch 9. Further a serration 6 has a decreasing thickness towards its outer end, namely its tip 8. Even further a serration 6 has a decreasing thickness towards its opposite lateral sides 10, 11. The result of the rounded shape with decreasing thickness is that aerodynamic drag is reduced as well as the emission of noise during rotation of the wind turbine blade 1.

In FIG. 3 one can see that the trailing edge 3 includes a base plate 12 from which multiple parallel serrations 6 extend.

In this embodiment serrations 6 are printed with a 3D printer. Using this production technology serrations with slightly different dimensions and varying stiffness can be produced, if required. Serrations 6 and base plate 12 are made from a plastic material. Other materials are possible, too, for example casted plastic or metal, in particular aluminium or steel.

The use of a trailing edge 3 having serrations 6 with modified shape reduces the emission of noise during rotation of the wind turbine blade 1. Consequently wind turbines which are equipped with such wind turbine blades 1 can be built closer to residential areas.

Although the present invention has been described in detail with reference to the preferred embodiment, the present invention is not limited by the disclosed examples from which the skilled person is able to derive other variations without departing from the scope of the invention.

1. A wind turbine blade comprising:
a noise reducing device attached at its trailing edge comprising serrations,
wherein the serrations and the trailing edge include an angle between 75° and 90°.

2. The wind turbine blade according to claim 1, wherein said angle is between 80° and 90°.

3. The wind turbine blade according to claim 1, wherein a serration has a rounded shape at its tip and/or its notch.

4. The wind turbine blade according to claim 1, wherein a serration has a decreasing thickness towards its outer end.

5. The wind turbine blade according to claim 1, wherein a serration has a decreasing thickness towards its opposite lateral sides.

6. The wind turbine blade according to claim 1, wherein said serration has a length of 15% to 25% of a chord of the wind turbine blade.

7. The wind turbine blade according to claim 1, wherein the serrations are arranged in a section ranging approximately from 75% to 95% of the span of the wind turbine blade.

8. The wind turbine blade according to claim 1, wherein the serrations are printed by a 3D printer.

9. The wind turbine blade according to claim 1, wherein the serrations are made of casted plastic or cut out and machined from a plate.

10. A wind turbine, comprising:
a tower,
an electrical generator with a rotor shaft, and
a hub to which wind turbine blades are connected,
wherein the wind turbine comprises one or more wind turbine blades according to claim 1.

11. The wind turbine blade according to claim 2, wherein said angle is between 85° and 90°.

12. The wind turbine blade according to claim 6, wherein said serration has a length of approximately 20%.
